(19) United States
(12) Patent Application Publication
(10) Pub. No.: US 2023/0395782 A1
(43) Pub. Date: Dec. 7, 2023

(54) EXPANDING BATTERY MANDREL

(71) Applicant: The Aerospace Corporation, El Segundo, CA (US)

(72) Inventors: Eric Joseph NEMANICK, Santa Monica, CA (US); Justin STOCKER, Sherman Oaks, CA (US); Robert G. WILL, Redondo Beach, CA (US); Kevin MACDOUGALL, Torrance, CA (US)

(73) Assignee: The Aerospace Corporation, El Segundo, CA (US)

(21) Appl. No.: 17/832,007

(22) Filed: Jun. 3, 2022

(51) Int. Cl. H01M 4/1395; H01M 4/134; H01M 4/36

(52) U.S. Cl. CPC H01M 4/1395; H01M 4/134; H01M 4/366; H01M 10/0525

(57) ABSTRACT

An expanding battery mandrel includes a cylindrical cell, a cylindrical mandrel having a slit along a length of the cylindrical mandrel, and a plurality of electrolytes wrapped around the cylindrical cell. The expanding battery mandrel also includes an expander screwed inside of or inserted within the cylindrical mandrel, forcing the cylindrical mandrel to uniformly expand in a radial direction and forcing the plurality of electrolytes to compress against each other and to press against an inner wall of the cylindrical cell.

### FIELD

The present invention relates to solid state batteries, and more particularly, to an expanding mandrel for solid state battery.

### BACKGROUND

In assembly of conventional cylindrical liquid and gel based lithium (Li) battery cells, there are dry electrodes wrapped around a central mandrel, or central structure, forming a ‘jelly roll’ of spirally wound electrodes around the mandrel. The dry electrodes and central mandrel are placed inside a cell can. The addition of a liquid causes the electrodes to swell, creating compression of the electrodes against themselves and the cell outer structure.

When there is a physical gap or space between electrodes filled with air, vacuum, or other nonconductive substance, electrodes cannot effectively transfer ions between each other. For this reason, in the case of battery systems that do not use a liquid, gel, or other conformal electrolytes, solid state electrodes need to be pressed up against one another to create physical contact for the transfer of ions.

In conventional liquid or gel electrolyte batteries, the dry electrodes are placed inside of the can, and electrolytes are poured inside of the can. Through capillary action, the electrodes swell up, pressing up against the wall of the can and against one another. This creates the tight fit and ensures physical contact between the electrodes.

In solid state batteries, where the liquid or gel electrolyte is replaced with a solid ion conducting material like a polymer or ceramic, there is a need for the dry electrodes to be compressed together for good ionic contact. However, with solid state batteries, there is no electrolyte swelling effect, i.e., they do not have poured electrolytes creating the swelling and resulting tight fit.

Instead, typical builds for solid state batteries use external compression to ensure uniform contact between the electrodes. In this conventional construction, the cells are layered in a sandwich and external compression is applied. If the solid state materials are to be used in a cylindrical form, with electrodes spirally wound into a cylinder, compression must be generated.

Currently, there are no known methods for generating high compression on spiral wound electrodes in a cylindrical format. Additionally, existing all solid state cell designs use planar compression of flat cell stacks to generate compression using devices like tie rods. This compression can be nonuniform over the cell stack, and tends to decline over life and materials relax (cold flow) under compression, reducing compression and degrading battery performance.

Solid state Li-ion battery technology replaces the porous polymer separator and the flammable organic electrolyte with a Li⁺ transporting ceramic or polymer. This not only removes the considerable fire risk from using flammable electrolytes, but also enables high rate charging and discharging by preventing electrolyte breakdown, and enables the use of high energy materials like Li metal.

Current designs that incorporate solid state ceramic and polymer electrolytes use high compression to ensure that the ion conducting solids maintain good contact and do not develop voids or breaks in the solid/solid interfaces over life, which would rapidly degrade battery performance, however, these external methods of compression are unreliable over the battery life, and add considerable mass to the structure that holds or contains the battery, increasing the overall battery mass.

The ultimate goal is to develop a method for generating compression of battery electrodes in a cylindrical cell, to enable manufacturing through roll to roll processing, the key to manufacturing batteries at high volume and low cost. This type of design will require compression between the electrodes, which can be generated from varying the mandrel size, compressing the electrodes. Thus, an alternative expanding solid battery mandrel is needed.

### SUMMARY

Certain embodiments of the present invention may provide solutions to the problems and needs in the art that have not yet been fully identified, appreciated, or solved by current battery technologies. For example, some embodiments of the present invention pertain to an expanding battery mandrel.

In one embodiment, an expanding battery mandrel includes a cylindrical cell and a cylindrical mandrel having a slit along a length of the cylindrical mandrel. The expanding battery mandrel also includes a plurality of electrolytes wrapped around the cylindrical cell, and an expander screwed inside of or inserted within the cylindrical mandrel, forcing the cylindrical mandrel to uniformly expand in a radial direction and forcing the plurality of electrolytes to compress against each other and to press against an inner wall of the cylindrical cell.

In another embodiments, a method for compressing a plurality of electrodes wrapped around a cylindrical mandrel includes performing a cell diagnostic. The performing of the cell diagnostics comprising measuring an impedance of the cell. The method also includes decreasing compression of the cell when impedance of the cell is low, or increasing compression of the cell when impedance of the cell is high.

In yet another embodiment, a battery includes a mandrel comprising a cylinder inside of the mandrel. The battery also includes an expander configured to be inserted inside of one or more ends of the cylinder inside of the mandrel. The insertion of the expander causes the mandrel to uniformly expand in an axial direction forcing a plurality of electrodes wrapped around the mandrel to compress against each other and against an inner wall of a cell can.

In another embodiment, a battery includes a mandrel comprising a cylinder inside of the mandrel. The mandrel has one or more slits running the length of the mandrel with material connecting the mandrel together as a whole. The battery also includes two areas that press on the ends of this mandrel during cell manufacture that compresses the mandrel axially causing the mandrel to expand uniformly in an axial direction forcing a plurality of electrodes wrapped around the mandrel to compress against each other and against an inner wall of a cell can.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a diagram illustrating a cross section of an expanding mandrel within a cylindrical can, according to an embodiment of the present invention.

FIG. 2 is a diagram illustrating an expander being inserted inside of (or twisted into) mandrel, according to an embodiment of the present invention.

FIG. 3 is a diagram illustrating a mandrel and an expander (e.g., shim) 320, according to an embodiment of the present invention.

FIG. 4 is a diagram illustrating a mandrel inside of a cylindrical can, according to an alternate embodiment of the present invention.

FIG. 5 is a flow diagram illustrating a process by which a cell built with an expanding battery mandrel can be used to alter the cell compression during usage, according to an embodiment of the present invention.

FIGS. 6A-B is a diagram illustrating a battery changing through usage where the internal compression has changed, according to an embodiment of the present invention.

### DETAILED DESCRIPTION OF THE EMBODIMENTS

Some embodiments of the present invention pertain to an expanding mandrel for a battery. For example, the expanding mandrel (hereinafter “mandrel”) achieves necessary compression in a cylindrical cell through the mechanical force of a screw or shim mechanically expanding the mandrel laterally around which the electrodes are wrapped, or through longitudinal compression of the mandrel generating an outward bowing and electrode compression. This compression of the electrodes can be up to the burst strength of the cell can or failure point of the electrodes, and may create the required compression of the roll of electrodes, perpendicular to the electrode surfaces. The mandrel and its expander (i.e., screw, shim, cap, etc.) can be sized to the required cell compression and electrode parameters to achieve good compression over cell life.

In some embodiments, a core for a cylindrical battery may contain a screw (i.e., expander) to turn (i.e., be inserted) into the core to laterally expand the core creating compression in the electrode (i.e., cell jelly roll). Cell jelly roll may be defined as two or more electrodes layered on each other with a separator and/or electrolyte between them, rolled into a spiral cylinder. This compression is necessary for solid state batteries to maintain compression on the electrode during cycling throughout life. Without this compression, the cell starts to lose contact in its rolled up configuration, increasing cell impedance, creating voids or spaces in the electrode, and preventing the cell from charging/discharging. This device comprises of a rigid cylinder or similar elongated object (i.e., oval, square, pentagonal, hexagonal cross section) serving as the mandrel for winding the electrode, or be inserted afterwards. An expander (i.e., shim or screw) is then inserted into the core, where this expander has a larger diameter than the core. By turning or pressing the expander into the core, the core expands outwards laterally creating compression of the electrodes against each other and the walls of the cell can and mandrel.

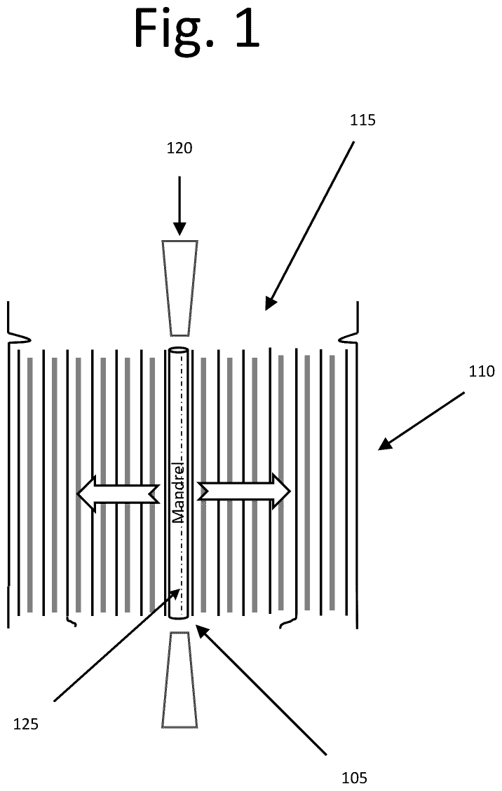

FIG. 1 is a diagram illustrating a cross section of an expanding mandrel 105 within a cylindrical can 110, according to an embodiment of the present invention. In some embodiments, mandrel 105 includes a slit 125 running across the length of its body to allow for material expansion. Electrodes 115 are wrapped around mandrel 105 to form a jelly roll.

In certain embodiments, mandrel 105 may switch between an expanded state and an unexpanded state. Regardless of the state, mandrel 105 resides within a cylindrical cell 110.

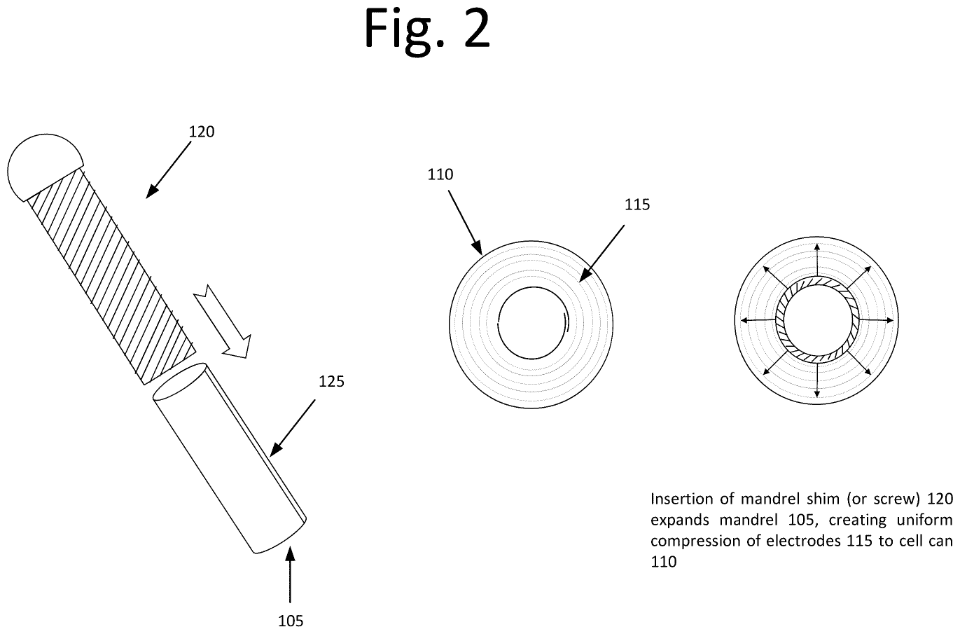

To switch the state of the mandrel and to create compression, expander (e.g., shim) 120 is inserted inside of mandrel 105. It should be appreciated that slit 125 allows for expander 120 to be inserted into (or inside of) mandrel 105. The insertion of expander 120 forces mandrel 105 to expand in an outward direction. For an embodiment that implements a screw as the expander, the screw is turned such that its threads drive the screw into the core, thereby expanding the core. See, for example, FIG. 2. For embodiments that implements a shim as the expander, the larger shim is pushed into the core to expand the core. The expansion of mandrel 105 forces electrodes 115 to also press outwards. As mandrel 105 expands, electrodes 115 are forced to compress against each other, and also compress against the inner wall of cylindrical wall 110. See, for example, FIGS. 1 and 2. It should be appreciated that the diameter of expander 120 is greater than the diameter of unexpanded mandrel 105, in some embodiments. This difference in diameter, coupled with slit 125, allows mandrel 105 to expand in a radial direction.

In embodiments that use a shim as the expander, a pair of shims, or one long shim, are inserted in opposite ends of mandrel 105 to create uniform lateral expansion of mandrel 105. See expander 120 in FIG. 1. Similar to the embodiment that uses a screw, electrodes 115 also compress tightly against each and against the wall of cylindrical cell 110. See expander 120 in FIG. 2.

FIG. 2 is a diagram illustrating an expander 120 being inserted inside of (or twisted into) mandrel 105, according to an embodiment of the present invention. As discussed above, mandrel 105 includes a slit 125. This slit 125 allows for mandrel 105 to expand as expander 120 is inserted in mandrel 105. Because screw 120 is uniform, mandrel 105 expands in a uniform manner. Again, this uniform expansion of mandrel 105, creations uniform compression of electrode 115 and against the wall of cylindrical cell 110.

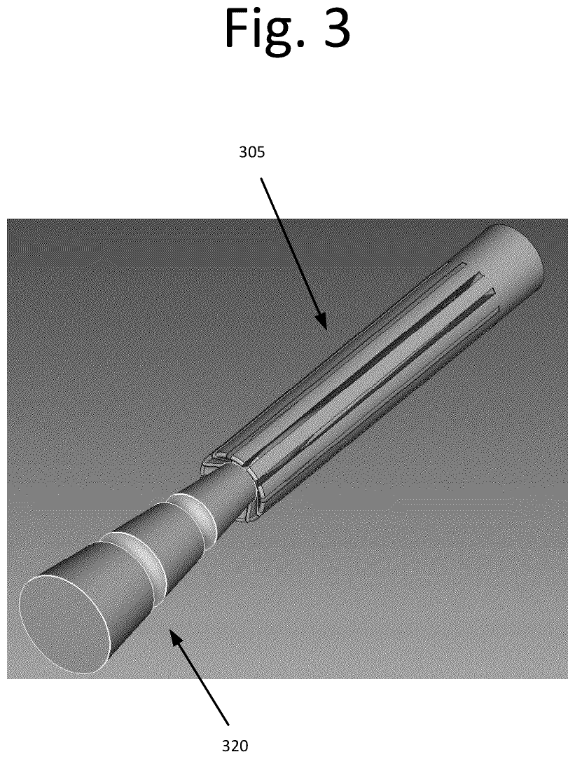

FIG. 3 is a diagram illustrating a mandrel 305 and an expander (e.g., shim) 320, according to an embodiment of the present invention. In this embodiment, expander 320 is inserted inside of mandrel 305. This mandrel 305 has multiple slits 310 running the length of mandrel 305 in a barrel stave like fashion. Slits 310 may run the entire length of mandrel 305, with only small areas without slits 310 for mandrel structural integrity. Multiple slits 310 of mandrel 305 allow for uniform expansion of mandrel 305 outwards creating compression of the electrodes (not shown) as the force of expander 320 insertion is uniformly distributed radially to the electrodes. This embodiment may use a single expander inserted from one end of the mandrel, or may use two expanders (see FIG. 1) inserted from either (or both) side of the barrel like mandrel.

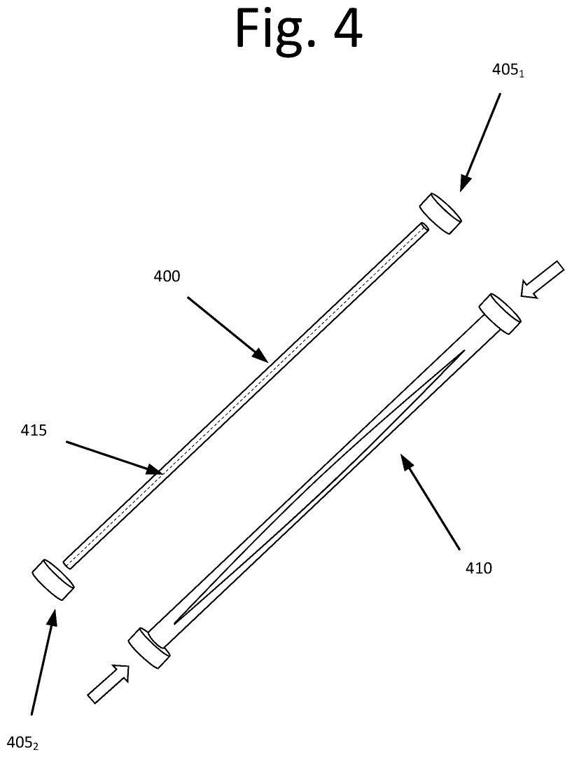

FIG. 4 is a diagram illustrating a mandrel 400 inside of a cylindrical can 410, according to an alternate embodiment of the present invention. In this embodiment, structures 4051 and 4052 are at opposite ends of cylindrical can 410, and mandrel 400 has slits 415 running the length of mandrel 400. In this embodiment, expander is not inserted into mandrel 400 to create lateral expansion, but rather the mandrel is compressed longitudinally creating outward bowing or deflection of the mandrel walls.

Structures 4051 and 4052 are pressed on the opposite ends of mandrel 400 (or cylindrical can 410), and the force of this compression causes mandrel 400 to bow outwards. This outwards bowing creates even radially distributed compression on the electrodes (not shown) wound around mandrel 400, ensuring good ionic conductivity between the cell electrodes. The pressing of structures 405₁ and 405₂ can be directly applied to these force transfer structures, or structures 405₁ and 405₂ can be part of the cell can 410 and cell cap(s), and assembly of the cell can 410 place the cap(s) on the cell with sufficient force to longitudinally compress mandrel 400 generating the desired cell roll radial compression. This pressure can be applied through external fixturing pressing on the mandrel, or through pressure on caps that are part of the cell which transfer that pressure to the mandrel.

It should be appreciated that this capability extends past the fabrication of the cell to improve performance. Battery cells age from usage, with gas being formed internally from operation, mechanical changes from repeated swelling during cycling, and external pressure changes due to the environment where the battery is being used. These changes impair the performance of the cell through increasing or decreasing the internal compression of the cell. Higher compression can lead to internal cell short circuits, where two electrodes are pressed together so hard that the electrically insulating material between the anode and cathode is pierced. Lower compression can lead to poor electrical and ionic conductivity, resulting in cell heating and energy stored being lost.

To overcome these issues, the expanding battery mandrel can act during life to alter the internal compression of the cell in response to cell aging or other changes to improve battery safety and performance. As conditions within the cell change, including increasing or decreasing pressure on the electrodes, the expanding mandrel is used to alter this compression. By expanding or contracting the mandrel, the pressure on the electrodes is altered, reducing the deviant pressure within the cell, reducing or eliminating a hazardous or performance altering condition in the cell, extending cell life and improving cell safety.

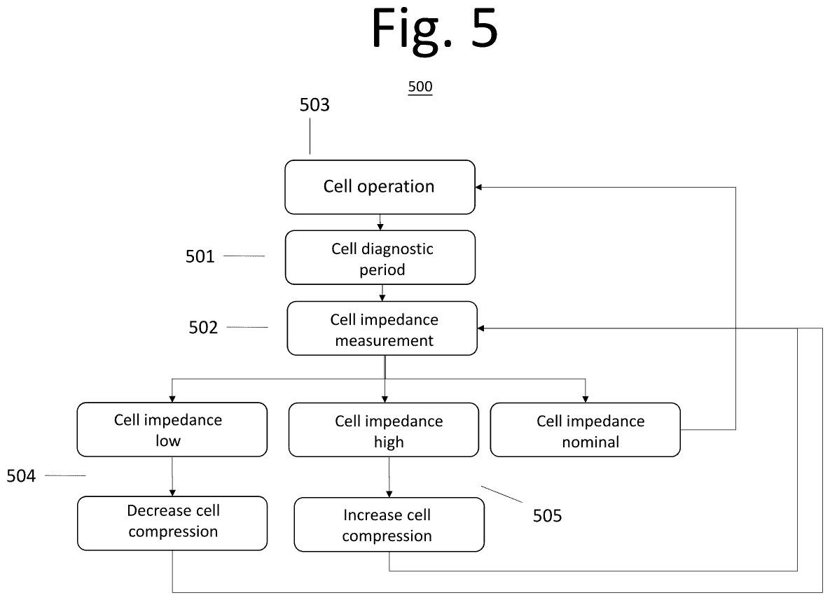

FIG. 5 is a flow diagram illustrating a process 500 by which a cell built with an expanding battery mandrel can be used to alter the cell compression during usage, according to an embodiment of the present invention. In some embodiments, process 500 may begin with cell diagnostic period 501. This cell diagnostic period can either be a time when the battery is not in use, or during another time at which cell diagnostics can occur. An example is an electric vehicle, where the battery can be tested when the vehicle is not in use, or has been idled for maintenance.

When the cell is available to perform measurements on itself without disturbing the cell's usage, such as when the battery's load is off, isolated, or if cell impedance measurements can be performed in a non-disturbing manner, process 500 moves to step 502. Non-disturbing in this case means testing the battery or cell in place, without needing to remove or alter the battery's physical connections.

In step 502, a measurement of the cell impedance is performed. In this measurement, the cell electrical and ionic conductivity and impedance is measured. For cells with low impedance, where the measured impedance Iₘ of the cell is lower than a predefined target or baseline impedance I_{b} and the acceptable deviation Δ from I_{b} as defined prior to this measurement, step 504 is enacted. Put simply, when cell impedance is low, process 500 moves to step 504. Baseline impedance I_{b} and acceptable deviation Δ will be defined at the battery design stage. In step 504, the cell's internal impedance is raised by decreasing the cell compression. Process 500 may then return to step 502 for verification of cell's impedance by measuring the cell impedance Iₘ′ and verifying that it is within α. See step 502, cell impedance measurement.

For cells with a higher than baseline impedance (i.e., when the cell's impedance is high, where the measured impedance Iₘ of the cell is higher than a predefined target or baseline impedance I_{b} and the acceptable deviation Δ from I_{b} as defined prior to this measurement), the cell compression can be raised. See, for example, step 505 in which the cell's compression is increased. Increments of increasing cell compression can be defined prior to cell build in the battery design phase, or can be iteratively performed by incrementing a minimum compression step and reverification when the cell returns to step 502. After the cell's compression is increased, and process 500 returns step 502 for impedance verification.

For cells with an impedance within the measurement delta Δ of I_{b} (i.e., cell's impedance being nominal), process 500 returns to step 503, which is returning the cell to normal operation.

It should be appreciated that, with both steps 504 and 505, the compression of the cell is altered using the expanding battery mandrel as was performed during the assembly steps above, where a screw is turned or shim inserted. For decreasing compression, the screw is turned in the opposite direction to back the screw out, or the shim is backed out.

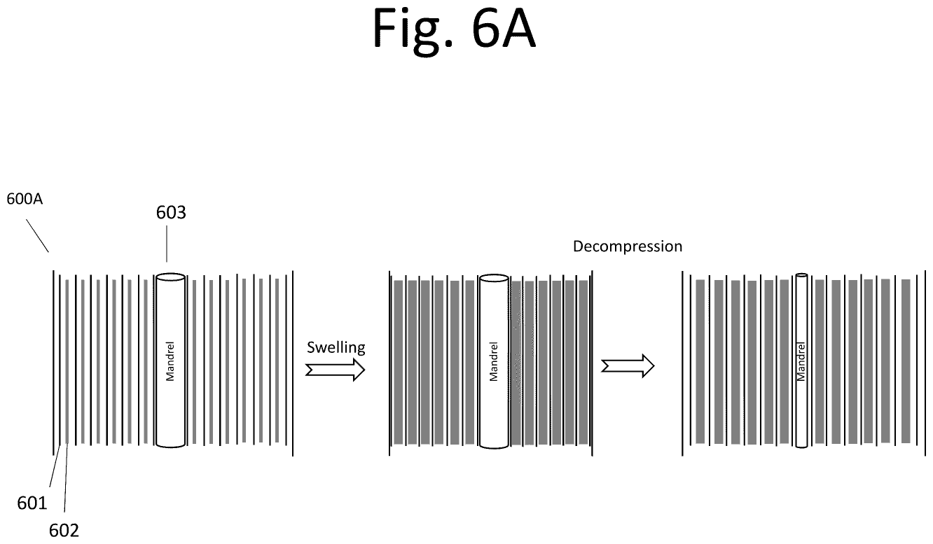

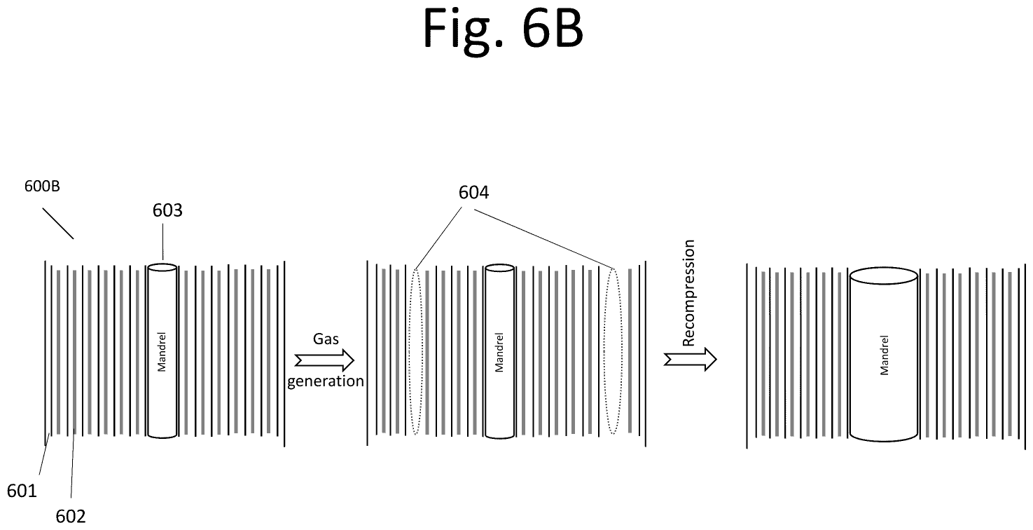

FIGS. 6A-B is a diagram illustrating a battery changing through usage where the internal compression has changed, according to an embodiment of the present invention. In FIG. 6A, element 600A, the expanding mandrel equipped battery, includes anodes 601 and cathode 602. In this example, cathodes 602 undergo swelling from a chemical change over battery usage life. This can occur, for example, in silicon battery materials through repeated swelling and contraction leaving a larger electrode, or layered cathode materials such as nickel cobalt aluminum oxide or nickel manganese cobalt oxide suffering irreversible expansion from repeated lithium intercalation. The swelling of cathodes 602 creates compression of the electrode roll, increasing the risk of the cell generating a short circuit, and reducing cell performance. This cell may have its mandrel 603 reduced in diameter to decrease the cell stack compression and returning the cell to nominal performance.

In FIG. 6B, the cell undergoes gas generation from a chemical change in the cell over life. This can occur in Li-ion batteries through oxidation of electrolytes, polymers, and binders forming COₓ, H₂, CH₄ and other gasses. Non-conducting gas pockets 604 within cell 600B cause open circuit conditions between portions of the electrodes, reducing cell performance. In this embodiment, cell 600B may have its mandrel 603 increase in diameter, compressing the electrode cell stack and pushing the gas pockets out of the electrode roll to restore cell function.

This capability can extend the life and improve the operation of the battery by allowing dynamic modification of battery internal compression over life. As cells age, their impedance growth from lowered internal compression can cause a reduction in energy storage efficiency, reducing the range of electric vehicles or time between charging for personal electronics. For batteries that have an increased internal compression during operation, this capability can reduce short circuit and fire risks from electrodes being pressed too firmly together damaging the cell separator, or compression leading to lithium metal plating, which can pierce the separator and lead to short circuits. By reducing this pressure, both risks for short circuits can be mitigated.

### TECHNOLOGICAL BENEFITS

In some embodiments, the expanding mandrel enables high rate fabrication and processing of solid state electrodes into a cylindrical format. For example, a cylindrical format is the dominant Li-ion battery morphology due to the rapid, inexpensive roll to roll processing, allowing for low cost manufacturing. Cylindrical cells are also more mechanically robust than prismatic (rectangular) cells due to a lack of corners.

Although some embodiments of existing solid state batteries may be limited to planar designs due to lack of method to compress cell roll in a can without liquids, insertion of solid state cells into current cylindrical cell manufacturing process may be enabled by some embodiments.

Dynamic access to screw or shim after assembly and during battery usage may enable adjustment of cell compression over life, responding to changes in cell compression from degradation of cell materials and plastic flow of components. This enables a method whereby the performance of the cell may be improved over life through the adjustment of internal cell compression to compensate for changes in the cell morphology from usage.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. An expanding battery mandrel, comprising:
a cylindrical cell;
a cylindrical mandrel comprising a slit along a length of the cylindrical mandrel;
a plurality of electrolytes wrapped around the cylindrical cell; and
an expander screwed inside of or inserted within the cylindrical mandrel, forcing the cylindrical mandrel to uniformly expand in a radial direction and forcing the plurality of electrolytes to compress against each other and to press against an inner wall of the cylindrical cell.

2. The expanding battery mandrel of claim 1, wherein the cylindrical cell is inside of the cylindrical can and the cylindrical can comprises an internal hollow cylinder for which the expander is screwed inside of or inserted within.

3. The expanding battery mandrel of claim 1, wherein, when the expander is a screw, the screw is larger in diameter than the cylindrical mandrel, a difference in diameter between the screw and cylindrical mandrel forces the cylindrical mandrel to expand towards the inner wall of cylindrical cell.

4. The expanding battery mandrel of claim 1, wherein, when the expander is a shim, the shim is conical in shape, and the conical shaped shim forcing the cylindrical mandrel to expand towards the inner wall of cylindrical cell.

5. The expanding battery mandrel of claim 1, wherein the slit is along an entire length of the cylindrical mandrel, allowing the cylindrical mandrel to expand uniformly in a radial direction when the expander is screwed into the cylindrical mandrel.

6. The expanding battery mandrel of claim 1, wherein each end of the cylindrical mandrel comprise a plurality of slits along a majority of the length of the cylindrical mandrel, allowing the cylindrical mandrel to expand in a radial direction when the expander is inserted within the cylindrical mandrel.

7. The expanding battery mandrel of claim 1, further comprising:
a first structure and a second structure pressed against opposite ends of the cylindrical mandrel, creating an outward bowing of the cylindrical mandrel, the outward bowing creates compression of the plurality of electrodes.

8. A method for compressing a plurality of electrodes wrapped around a cylindrical mandrel, comprising:
performing a cell diagnostic, wherein the performing of the cell diagnostics comprising measuring an impedance of the cell; and
decreasing compression of the cell when impedance of the cell is low, or
increasing compression of the cell when impedance of the cell is high.

9. The method of claim 8, wherein the impedance of the cell is low, when the measured impedance Iₘ of the cell is lower than a predefined target or baseline impedance I_{b}.

10. The method of claim 8, wherein the impedance of the cell is high, when the measured impedance Iₘ of the cell is greater than a predefined target or baseline impedance I_{b}.

11. The method of claim 8, further comprising:
continuously measuring the impedance of the cell when the impedance of the cell is nominal,
the impedance of the cell is nominal when the impedance of the cell is within a measurement delta Δ of the baseline impedance I_{b}.

12. The method of claim 8, wherein the decreasing compression of the cell comprises creating separation between a plurality of electrodes wrapped around a mandrel.

13. The method of claim 8, wherein the increasing compression of the cell comprises compressing a plurality of electrolytes against each other and to press against an inner wall of the cell.

14. The method of claim 8, wherein the decreasing compression of the cell comprises removing one or more expanders from one or both ends of a mandrel.

15. The method of claim 8, wherein the increasing compression of the cell comprises inserting one or more expanders from one or both ends of a mandrel.

16. A battery, comprising
a mandrel comprising a cylinder inside of the mandrel; and
an expander configured to be inserted inside of one or more ends of the cylinder inside of the mandrel, wherein
the insertion of the expander causes the mandrel to uniformly expand in an axial direction forcing a plurality of electrodes wrapped around the mandrel to compress against each other and against an inner wall of a cell can.

17. The battery of claim 16, wherein, when the expander is a screw, the screw is larger in diameter than the cylinder, a difference in diameter between the screw and the cylinder forces the mandrel to expand towards the inner wall of cell can.

18. The battery of claim 16, wherein, when the expander is a shim, the shim being conical in shape forces the mandrel to expand towards the inner wall of cell can.

19. The battery of claim 16, wherein the mandrel including the cylinder comprises a slit across an entire or most of a length of the mandrel.

20. The battery of claim 19, wherein the expander being greater in diameter than the mandrel forces the mandrel to expand uniformly in the radial direction when the expander is screwed or inserted into the mandrel.
